(19) United States
(12) Patent Application Publication
(10) Pub. No.: US 2012/0054028 A1
(43) Pub. Date: Mar. 1, 2012

(54) METHOD OF ADVERTISING TO A TARGETED VEHICLE

(75) Inventors: Steven C. Tengler, Grosse Pointe Park, MI (US); Mark S. Frye, Grosse Pointe Woods, MI (US); Timothy R. Nixon, Northville, MI (US)

(73) Assignee: GENERAL MOTORS LLC, DETROIT, MI (US)

(21) Appl. No.: 12/872,664

(22) Filed: Aug. 31, 2010

(51) Int. Cl. G06Q 30/00; G01C 21/36

(52) U.S. Cl. 705/14.49; 701/438

(57) ABSTRACT

A method of advertising to a targeted vehicle involves, via a processor at a service center, determining at least one vehicle navigation route to a point of interest, and identifying a marketing agency that represents an entity that is at least one of i) associated with the point of interest, or ii) offering at least one of goods or services directed toward at least one occupant of the targeted vehicle traveling along the vehicle navigation route(s). The method further involves offering, to the marketing agency, advertisement space on a medium external to the targeted vehicle and located along the vehicle navigation route(s). Upon receiving an acceptance of the offer, via the processor at the service center, a command is submitted to a third party facility to display an advertisement of the marketing agency on the medium, where the advertisement is directed to the targeted vehicle.

### TECHNICAL FIELD

The present disclosure relates generally to methods of advertising to a targeted vehicle.

### BACKGROUND

Billboards or other roadside communication devices are often used as advertising space for marketing agencies to advertise goods and/or services to oncoming traffic. Typically, the content of the advertisements placed on these roadside devices is directed toward any vehicle traveling along the road segment.

### SUMMARY

A method of advertising to a targeted vehicle is disclosed herein. The method involves, via a processor at a service center, determining at least one vehicle navigation route to a point of interest and identifying a marketing agency that represents an entity that at least one of i) is associated with the point of interest, or ii) offers at least one of goods or services directed toward at least one occupant of the targeted vehicle traveling along the vehicle navigation route(s). The method further involves offering, to the marketing agency, advertisement space on a medium external to the targeted vehicle and located along the vehicle navigation route(s). Upon receiving an acceptance of the offer, via the processor at the service center, a command is submitted to a third party facility to display an advertisement of the marketing agency on the medium, where the advertisement is directed to the targeted vehicle.

### BRIEF DESCRIPTION OF THE DRAWING

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for advertising to a targeted vehicle; and

FIG. 2 is a schematic diagram depicting an example of a method for advertising to a targeted vehicle.

### DETAILED DESCRIPTION

Example(s) of the method disclosed herein may be used to direct an advertisement to a targeted vehicle traveling along a road segment, where the advertisement is displayed on an advertising medium that is external to the vehicle. In instances where the advertising medium is electronic (such as an electronic billboard), advertisements presented on the medium may be changed in real time to target other vehicles that are also traveling along the same road segment. This advertising scheme advantageously improves the economy for the marketing agencies, whereby a particular advertisement is displayed to a vehicle that is most likely interested in the goods/services being advertised. This is in contrast to providing a single advertisement or a sequence of randomly selected advertisements to all oncoming traffic with the off chance that one of the vehicles may be interested in the goods/services being advertised.

It is to be understood that, as used herein, the term “user” includes a vehicle owner, a vehicle driver, and/or a vehicle passenger. In some instances, the term “user” may be used interchangeably with the term subscriber/service subscriber.

Additionally, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Furthermore, the term “communication” is to be construed to include all forms of communication, including direct and indirect communication. As such, indirect communication may include communication between two components with additional component(s) located therebetween.

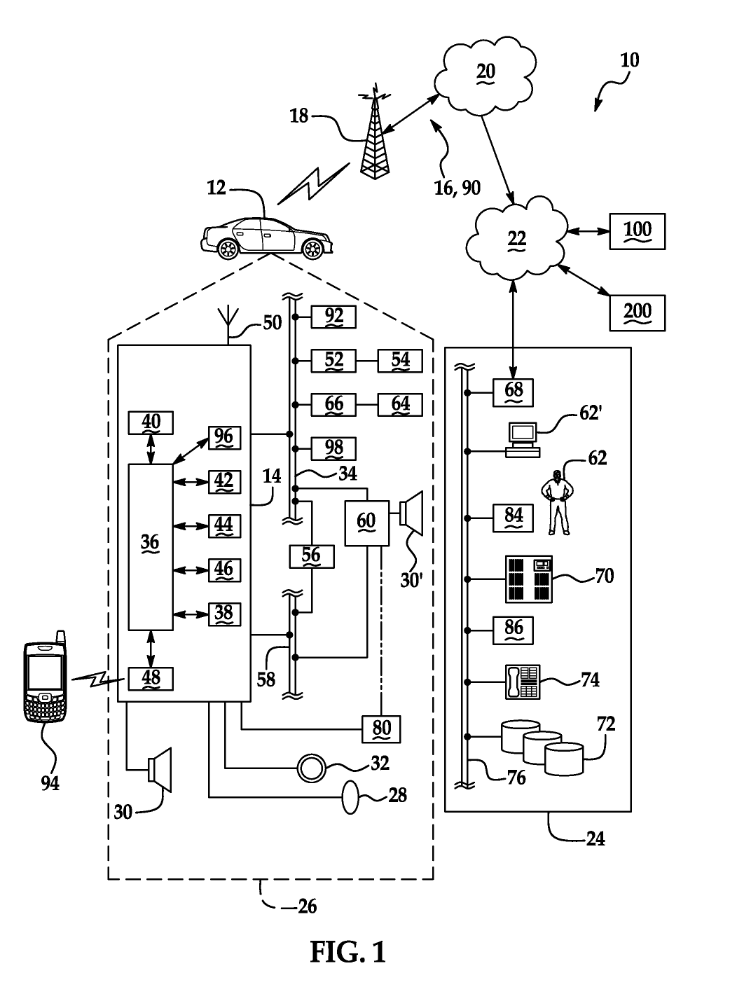

FIG. 1 described in detail below depicts a system (identified by reference character 10) of advertising to a targeted vehicle. The system 10 generally includes the targeted vehicle 12 (which may, in some examples, represent a plurality of targeted vehicles), a telematics unit 14 operatively disposed in the mobile vehicle 12, a carrier/communication system 16 (including, but not limited to, one or more cell towers 18, one or more base stations 19 and/or mobile switching centers (MSCs) 20, and one or more service providers (not shown) including mobile network operator(s)), one or more land networks 22, and one or more telematics service/call centers 24. In an example, the carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of the system 10. It is to be understood, however, that additional components and/or other systems not shown here could employ the method(s) disclosed herein.

Vehicle 12 is a mobile vehicle, such as a motorcycle, car, truck, recreational vehicle (RV), boat, plane, etc., and is equipped with suitable hardware and software that enables it to communicate (e.g., transmit and/or receive voice and data communications) over the carrier/communication system 16.

Some of the vehicle hardware 26 is shown generally in FIG. 1, including the telematics unit 14 and other components that are operatively connected to the telematics unit 14. Examples of other hardware 26 components include a microphone 28, a speaker 30, and buttons, knobs, switches, keyboards, and/or controls 32. Generally, these hardware 26 components enable a user to communicate with the telematics unit 14 and any other system 10 components in communication with the telematics unit 14. It is to be understood that the vehicle 12 may also include additional components suitable for use in, or in connection with, the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections, such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard vehicle dedicated communications device that provides a variety of services, both individually and through its communication with the call (or data) center 24. The call (or data) center 24 are facilities that are owned and operated by a telematics service provider. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), a recorder 96, and/or a dual antenna 50. In one example, the wireless modem 42 includes a computer program and/or set of software routines executing within processing device 36.

It is to be understood that the telematics unit 14 may be implemented without one or more of the above listed components (e.g., the short range wireless communication network 48). It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor. In a non-limiting example, the electronic processing device 36 (also referred to herein as a processor) includes software programs having computer readable code to initiate and/or perform various functions of the telematics unit 14.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies, such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request date and time information. In an example, the RTC 46 may provide date and time information periodically, such as, for example, every ten milliseconds.

The electronic memory 38 of the telematics unit 14 may be configured to store data associated with the various systems of the vehicle 12, vehicle operations, vehicle user preferences and/or personal information, and the like.

In an example, the telematics unit 14 may include a recorder 96, which is configured to capture a voice print of one or more vehicle occupants. The recorder 96 includes suitable hardware and/or software integrated into the telematics unit 14 for recording auditory utterances from inside the cabin area of the vehicle 12 on command from the telematics unit 14. The voice print may be used to deduce a demographic of the vehicle occupant(s). In an example, this may be accomplished via the processor 36 by comparing the voice print to generic, demographical voice files stored in the electronic memory 38 to obtain a probable identification of the speaker. In another example, the user may generate a voice print via an Internet enabled program, and then download the voice print to the telematics unit 14, which is stored in the electronic memory 38. The voice print captured by the recorder 96 may be compared with the downloaded voice print to identify the speaker. In still another example, the voice print generated via the Internet enabled program may be downloaded and stored at the service center 24, and this voice print may be used, by the telematics unit 14, to make a comparison with the recorded voice print.

The telematics unit 14 provides numerous services alone or in conjunction with the call/data center 24, some of which may not be listed herein, and is configured to fulfill one or more user or subscriber requests. Several examples of these services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering. It is to be understood that when these services are obtained from the call/data center 24, the telematics unit 14 is considered to be operating in a telematics service mode.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

The microphone 28 provides the user with a means for inputting verbal or other auditory commands, and can be equipped with an embedded voice processing unit utilizing human/machine interface (HMI) technology known in the art. Conversely, speaker(s) 30, 30′ provide verbal output to the vehicle occupants and can be either a stand-alone speaker 30 specifically dedicated for use with the telematics unit 14, or can be part of a vehicle audio component 60, such as speaker 30′. In either event and as previously mentioned, microphone 28 and speaker(s) 30, 30′ enable vehicle hardware 26 and telematics service data/call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the telematics service provider data/call center 24 (whether it be a live advisor 62 or an automated call response system 62′) to request emergency services, for example.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system (e.g., speaker 30′), or may utilize speaker 30 via arbitration on vehicle bus 34 and/or audio bus 58.

Still referring to FIG. 1, the vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain vehicle data for use by the telematics unit 14 or the data/call center 24 (when transmitted thereto from the telematics unit 14) to determine the operation of the vehicle 12. Non-limiting example sensor interface modules 66 include powertrain control, climate control, body control, and/or the like.

In a non-limiting example, the vehicle hardware 26 includes a display 80, which may be operatively directly connected to or in communication with the telematics unit 14, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

In an example, the vehicle 12 further includes a navigational radio 92, which operates as an in-vehicle navigation system as well as an AM/FM radio. As shown in FIG. 1, the navigational radio 92 may be part of the vehicle hardware 26, and may be in communication with the in-vehicle telematics unit 14 via the vehicle bus 34. The navigational radio 92 may otherwise be a portable unit that is manually connected to the telematics unit 14 via a suitable connector (not shown in FIG. 1). With either configuration, the navigational radio 92 is configured to interact with various in-vehicle 12 systems including, but not limited to, the in-vehicle location detection system 44, vehicle sensors 54 and 64, and the electronic processor 38. The navigational radio 92 generally utilizes data retrieved from these foregoing vehicle systems and/or data input by a vehicle 12 occupant to provide the occupant with information (such as, e.g., maps, turn-by-turn routes, etc.) pertaining to his/her travels. As will be described in further detail below, the vehicle 12 occupant may, in one example, request a route to a desired point of interest by inputting the request directly into the navigational radio 92. The radio 92 utilizes the data included in the request to generate an appropriate navigation or turn-by-turn route for the vehicle 12 occupant.

In yet another example, the vehicle occupant may submit his/her request for a navigation route to a desired destination using a mobile communications device 94 having internal processing capabilities. Examples of mobile devices 94 include a smart phone, a laptop computer having voice calling software such as SKYPE®, or the like. Via the short range wireless communication network 48 (e.g., the BLUETOOTH® unit), the mobile device 94 may be paired with the telematics unit 14. Pairing between the mobile device 94 and the telematics unit 14 is generally accomplished when the telematics unit 14 and the mobile device 94 exchange security codes/passwords with each other, which enables the telematics unit 14 and the mobile device 94 to communicate via a secured connection. Once the two units 14, 94 have been paired, the telematics unit 14 can directly communicate with the mobile device 94 such as, e.g., to display a requested navigation route retrieved via the mobile device 94.

Yet further, the vehicle 12 may include one or more imaging devices 98. In an example, the vehicle 12 includes a single imaging device 98, and this device 98 may be a rotatable camera, such as a reverse parking aid camera, operatively disposed in or on the vehicle 12 and in communication with the vehicle bus 34. In other instances, the vehicle 12 may include more than one imaging device 98. In these instances, the imaging devices 98 may include multiple cameras (that may be rotatable) disposed at predetermined positions in and/or on the vehicle 12. The imaging device(s) 98 may be used to obtain images of a vehicle cabin area including one or more vehicle occupants. As will be described below, the images may be transmitted to the service center 24, which uses the images to deduce a demographic of the vehicle occupants while the vehicle 12 is traveling along a particular road segment or the like.

A portion of the carrier/communication system 16 may be a cellular telephone system or any other suitable wireless system that transmits signals between the vehicle hardware 26 and land network 22. According to an example, the wireless portion of the carrier/communication system 16 includes one or more cell towers 18, base stations 19 and/or mobile switching centers (MSCs) 20, as well as any other networking components required to connect the wireless portion of the system 16 with land network 22. It is to be understood that various cell tower/base station/MSC arrangements are possible and could be used with the wireless portion of the system 16. For example, a base station 19 and a cell tower 18 may be co-located at the same site or they could be remotely located, or a single base station 19 may be coupled to various cell towers 18, or various base stations 19 could be coupled with a single MSC 20. A speech codec or vocoder may also be incorporated in one or more of the base stations 19, but depending on the particular architecture of the wireless network 16, it could be incorporated within an MSC 20 or some other network components as well.

Land network 22 may be a conventional land-based telecommunications network that is connected to one or more landline telephones and connects the wireless portion of the carrier/communication network 16 to the call/data center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks, such as wireless local networks (WLANs) or networks providing broadband wireless access (BWA), or any combination thereof

The call/data centers 24 of the telematics service provider (also referred to herein as a service center) are designed to provide the vehicle hardware 26 with a number of different system back-end functions. According to the example shown in FIG. 1, one service center 24 generally includes one or more switches 68, servers 70, databases 72, live and/or automated advisors 62, 62′, processing equipment (or processor) 84, a communications module 86, as well as a variety of other telecommunication and computer equipment 74 that is known to those skilled in the art. These various telematics service provider components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs enabling the processor 84 to accomplish a variety of service center 24 functions. For instance, the processor 84 may be configured to determine at least one navigation route to a destination or point of interest in response to a request from the vehicle 12. As will be described in further detail below, the navigation route(s) generated by the service center 24 may be used, by the processor 84, to deduce where (e.g., on which road segments, highways, etc.) the vehicle 12 will most likely be traveling to reach the desired destination. As such, the navigation route(s) determined by the processor 84 are referred to herein as probable navigation route(s), at least in part because there is a high probability (i.e., it is more likely than not) that the vehicle 12 will be traveling along the route(s) to reach the desired destination. It is to be understood, however, that in instances where the navigation route is generated by the navigational radio 92 onboard the vehicle 12, the processor 84 can deduce, with a much higher probability than if the route was generated at the service center 24, where the vehicle 12 will most likely be traveling. This is due to the fact that the navigational radio 92 receives input directly from the in-vehicle location detection unit 44 and can revise the route in real time. This real time route information is transmitted to the processor 84.

Further, the various operations of the service center 24 are carried out by one or more computers (e.g., computer equipment 74) programmed to carry out some of the tasks of the service center 24. The computer equipment 74 (including computers) may include a network of servers (including server 70) coupled to both locally stored and remote databases (e.g., database 72) of any information processed.

The communications module 86 includes suitable communications equipment that enables the service center 24 to establish a communication with another entity such as, e.g., a marketing agency 100, the telematics unit 14 of the vehicle 12, etc. This equipment may, for instance, be capable of handling voice calls, packet data sessions, or other messaging-based communications between the service center 24 and the marketing agency 100 (e.g., via a circuit-switch network) or the telematics unit 14 (via, e.g., a packet data network), messaging (e.g., via VehComm), modems, TCP/IP supporting equipment, and/or the like. In an example, the communications module 86 may be configured to transmit requested telematics services (e.g., a requested navigation route to a desired destination or point of interest) to the telematics unit 14.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72.

It is to be appreciated that the service center 24 may be any central or remote facility, manned or unmanned, mobile or fixed, to or from which it is desirable to exchange voice and data communications. As such, the live advisor 62 may be physically present at the service center 24 or may be located remote from the service center 24 while communicating therethrough.

The communications network provider 90 generally owns and/or operates the carrier/communication system 16. The communications network provider 90 includes a mobile network operator that monitors and maintains the operation of the communications network 90. The network operator directs and routes calls, and troubleshoots hardware (e.g., cables, routers, network switches, hubs, network adaptors, etc.), software, and transmission problems. It is to be understood that, although the communications network provider 90 may have back-end equipment, employees, etc. located at the telematics service provider service center 24, the telematics service provider is a separate and distinct entity from the network provider 90. In an example, the equipment, employees, etc. of the communications network provider 90 are located remote from the service center 24 (as shown in FIG. 1). The communications network provider 90 provides the user with telephone and/or Internet services, while the telematics service provider provides a variety of telematics-related services (such as, for example, those discussed hereinabove). It is to be understood that the communications network provider 90 may interact with the service center 24 to provide services (such as emergency services) to the user.

While not shown in FIG. 1, it is to be understood that in some instances, the telematics service provider operates a data center (represented as the service center 24 in FIG. 1), which receives voice or data calls, analyzes the request associated with the voice or data call, and transfers the call to an application specific call center (not shown) associated with the telematics service provider. It is to be understood that the application specific call center may include all of the components of the data center, but is a dedicated facility for addressing specific requests, needs, etc. Examples of application specific call centers include, but are not limited to, emergency services call centers, navigation route call centers, in-vehicle function call centers, or the like.

In an example, the system 10 further includes the marketing agency 100 (mentioned above), which is a group or business that markets one or more goods and/or services to the public. The marketing agency 100 is in selective communication with the telematics service provider, so that representative(s) at the marketing agency 100 can be contacted regarding available advertising space for targeting advertisements to the vehicle(s) 12. The marketing agency 100 may, for example, represent one or more clients whose goods and/or services could be associated with a particular point of interest or destination. For instance, the marketing agency 100 may market hotel services for a particular client that operates a hotel or restaurant near a particular destination such as, e.g., a vacation spot. In another example, the marketing agency 100 may represent one or more clients whose goods and/or services could be directed to at least one occupant of the subscriber vehicle 12. The marketing agency 100 may also represent one or more clients whose goods and/or services can be linked to a demographic of the subscriber vehicle 12 and/or its occupants. The demographics may reveal that one or more of the vehicle occupants falls within an age group that is most appropriate for a particular type of goods/services. For example, the marketing agency 100 may be promoting a G-rated movie, and if the demographic of the vehicle 12 reveals that one or more of the vehicle occupant(s) are children, a service center advisor 62, 62′ can offer the marketing agency 100 advertising space to promote the G-rated movie. In an example, the service center 24 may be partnered with one or more facilities (such as, e.g., GOOGLE® or the like) having marketing relationships already established based, at least in part, on search criteria. The service center 24 may, in an example, contact the facility/ies to identify an appropriate marketing agency 100. The service center 24 may otherwise contact a marketing agency 100 directly based, at least in part, on a previous relationship established between the owner of the service center 24 and the marketing agency 100.

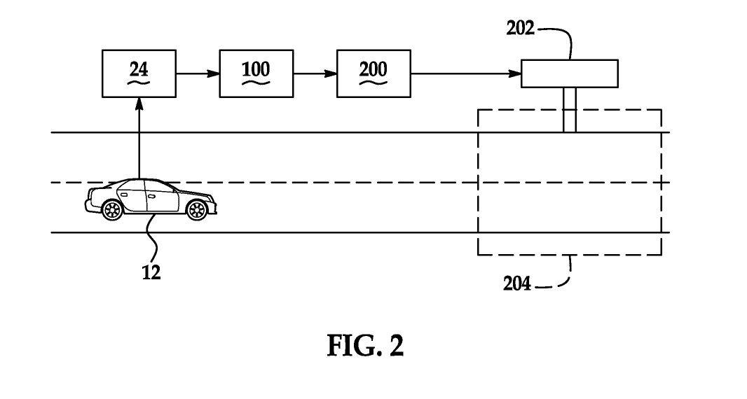

Examples of the method of advertising to a targeted vehicle will now be further described in conjunction with FIGS. 1 and 2. One example of the method very generally involves identifying the marketing agency 100 that represents an entity that i) is associated with a point of interest for which a navigation route was requested, and/or ii) offers goods/services directed toward at least one occupant of the vehicle 12 traveling along the requested navigation route, and then displaying an advertisement of the marketing agency 100 on a medium 202 along the requested navigation route. In this example, the vehicle 12 requesting the navigation route to the point of interest is targeted for a particular type of advertising. This targeting may, in some instances, be beneficial for the service center 24 (at least in terms of gaining revenue as an intermediate seller of advertising space), for the client(s) represented by the marketing agency 100 (at least in terms of increasing the probability that the targeted advertisements will be effective), as well as for the marketing agency 100 itself (at least in terms of providing advertising space for the client(s) represented by the agency 100). The targeted advertising may, in some instances, also be beneficial for the targeted vehicle 12, at least because one or more of the occupants of the vehicle 12 are apprised of goods/services that he/she/they may be interested in purchasing.

The instant example of the method begins by submitting a request for a vehicle navigation route to a particular, desired point of interest. In one example, the request is submitted to the service center 24. In this example, the request may be submitted by establishing a connection with the service center 24, and then requesting the navigation route from a service center advisor 62, 62′. The connection may be established, for instance, by activating the in-vehicle telematics unit 14 (e.g., by pressing a button 32 on the telematics unit 14, where the button 32, when pressed, automatically initiates a voice call to the service center 24), and then reciting the request into the microphone 28 operatively associated with the telematics unit 14. The connection may otherwise be established by calling the service center 24 using the vehicle 12 occupant's mobile device 94. In either case, when the voice call is initiated, the switch 68 routes the call to an appropriate division of the service center 24 (or to an appropriate call center if the service center 24 is a data center). The advisor 62, 62′ associated with the appropriate division will service the voice call when switched thereto. In the example described herein, the division is specifically designed to service vehicle navigation route requests, and upon receiving the routed voice call from the switch 68, the advisor 62, 62′ at the division generates (via, e.g., a software program executable by the processor 84) the requested navigation route.

The connection established with the service center 24 may otherwise be accomplished using the mobile communications device 94. The connection may be established by dialing the phone number of the service center 24, and an operator answers the phone call. The operator, who/which operates the switch 68, will direct the call to the appropriate division at the service center (or to an appropriate call center) as described above.

The navigation route may be generated, using appropriate software programs executable by the processor 84 at the service center 24, using then-current location information of the vehicle 12 and the desired point of interest. The service center 24 may retrieve the then-current GPS coordinate data of the vehicle 12 from the in-vehicle location detection unit 44 by pinging the telematics unit 14 for such information. The service center 24 may otherwise obtain the then-current location of the vehicle 12 directly from the caller. In instances where the then-current location of the vehicle 12 cannot be obtained by the service center 24 (e.g., if the location detection unit 44 in the vehicle 12 is not working properly or the caller is unaware of where he/she is), the requested route may be generated using the garage address of the subscriber stored in a subscriber profile in one of the databases 72 at the service center 24.

It is to be understood that the service center 24 may generate a plurality of routes to the desired point of interest, examples of which include the shortest route (in terms of distance), the quickest route (in terms of time), the most scenic route, a route that avoids certain geographic areas as requested by the vehicle 12, a route that runs through certain geographic areas as requested by the vehicle 12, and/or the like. It is further to be understood that although the foregoing routes are generated by the service center 24, there may be additional routes that the vehicle 12 may travel to the point of interest that the service center 24 did not account for. As such, the navigation routes generated by the service center 24 may be referred to herein as “probable navigation routes”; or those routes that the vehicle 12 is most like to take to arrive to the desired point of interest based, at least in part, on the request for a route.

Assuming that a plurality of routes is in fact generated, the service center 24 transmits one or more of the routes back to the vehicle 12. Typically, the service center 24 will transmit the shortest route (in terms of distance) back to the vehicle 12 as a default in instances where the vehicle 12 did not specify the type of route desired. If the vehicle user determines that the default route is undesirable, then the service center 24 may transmit an alternate route to the vehicle 12. In other instances, the service center 24 transmits all of the routes generated to the vehicle 12, and allows the vehicle user to select which route to take.

Further, when the vehicle navigation route request is made using the telematics unit 14, the service center 24 may, in some instances, transmit the route(s) right back to the telematics unit 14 during the same connection as the request. However, if the requested route is generated after the call is disconnected, then a separate data connection with the telematics unit 14 may be initiated by the service center 24, and the route(s) is/are transmitted to the vehicle 12 during that data connection. The latter case may also be utilized when the navigation route request was made using a device other than the telematics unit 14.

In an example, the service center 24 may deduce that the vehicle 12 is most likely going to use the navigation route (or one of many navigation routes) received from the service center 24 in response to the request when traveling to the desired point of interest. As mentioned above, the service center 24 may deduce that there is a higher probability that the vehicle 12 will take the route generated by the service center 24 and actually transmitted to the vehicle 12, as opposed to an alternate route that is, e.g., made up by the vehicle operator. In an example, if a single route transmitted from the service center 24 is accepted by the vehicle user, the processor 84 at the service center 24 may deduce that there is, for example, at least a 90% chance that the vehicle 12 will actually travel along the road segments, highways, or the like set forth in the navigation route. The probability that the vehicle 12 will travel along the road segments, etc. may be based upon a variety of known methods, which may include historical detour rates at various intersections along the route, historical detour or route cancellation rates of the user, historical detour rates of the sensed demographic, correlations to the severity of sensed traffic incidents along the route, and/or the like, and/or combinations thereof

In instances where the service center 24 downloads more than one alternate route to the vehicle 12, the service center 24 may await feedback from the telematics unit 14 as to which the route was selected or determine the probability that the user will select one of the routes. For example, if the user received multiple routes from the service center 24, the probability that the user will select the route with the most expressway travel over the route with the most local road travel will be relatively high.

In some cases, the service center 24 may transmit the desired point of interest to the telematics unit 14, which forwards it to the navigational radio 92 via the vehicle bus 34. The navigational radio 92 utilizes the information pertaining to the desired point of interest to calculate a route. In some instances, this calculated route may be based, at least in part, on the user's preferences such as, e.g., a preference to generate the shortest route. The navigational radio 92 forwards the calculated route to the telematics unit 14, which transmits the route (e.g., as packet data) back to the service center 24 (for identification of the marketing agency 100). The service center 24 may deduce that the vehicle 12 is most likely going to use the navigation route generated by the navigational radio 92 with a relatively high probability. Real time updates (described further hereinbelow) may be sent from the telematics unit 14 to the service center 24 so that the service center 24 knows if the user has varied from the requested route.

In instances where more than one vehicle navigation route is transmitted to the vehicle user, the processor 84 at the call center 24 will compare the routes to see if there are any common road segments, highways, or the like. If some commonality does exist, the processor 84 may deduce that there is a better chance or higher probability that the vehicle 12 will travel along that common road segment, highway, or the like. For example, if the vehicle 12 accepts two routes from Detroit, Mich. to Traverse City, Mich., and both of these routes include traveling northbound on I-75 between Detroit and Grayling, the processor 84 may deduce that there is a very high probability that the vehicle 12 will in fact travel northbound on I-75 between Detroit and Grayling when traveling to Traverse City.

As will be described in detail below, the probabilities or other statistical information discussed above may be used, by the processor 84, to identify particular advertising sites that are located along the road segments, highways, or the like upon which the vehicle 12 is most likely going to travel. In other words, these advertising sites are strategically identified so that the vehicle 12, which is most likely going to pass by that advertising site while traveling to the desired point of interest, is targeted for a particular type of advertising. Furthermore, the estimated time of arrival (ETA) for the vehicle 12 to arrive at the medium 202 may be calculated by the processor 84, for example, from the location and speed of the vehicle 12 and an extrapolation of the traffic times presently sensed on the selected route by a traffic provider. Utilizing a packet data channel, the telematics unit 14 may send GPS location information (retrieved from the location detection unit 44) and the time at which the route was requested (retrieved from the RTC 46) to the service center 24, and the processor 84 at the service center 24 utilizes the information to calculate the ETA. In some cases, the GPS location information and the time may be periodically sent from the telematics unit 14 to the service center 24 to confirm that the vehicle 12 has in fact adhered to the requested route. In another example, the ETA may be estimated, by the navigational radio 92, using the posted travel speed(s) of the various road segments, highways, etc. of the route. The ETA may be sent from the navigational radio 92 to the telematics unit 14, which transmits the information (e.g., as packet data) to the service center 24. It is to be understood that the ETA may be generated at the time of destination entry, or may be continually refined while traveling along the route.

In an example, the vehicle navigation routes may be generated by the processor 84 at the service center 24 in response to a user request for general information pertaining to a particular point of interest. For instance, the vehicle user may request, from the service center 24, the location of a particular amusement park in the state of Michigan, its hours of operation, etc. Utilizing the then-current location of the vehicle 12 (which may be retrieved by the service center 24 from the location detection system 44 of the vehicle 12), the processor 84 may automatically generate at least one probable navigation route from the then-current location of the vehicle 12 to the amusement park.

The navigation route generated by the service center 24 may be transmitted to the telematics unit 14 of the vehicle 12, which forwards the route to the display 80 (if the route is provided in text or graphics) and/or to the audio component 60 (if the route is provided with auditory commands). In instances where a mobile device 94 is paired with the navigational radio 92 or with the telematics unit 14 via a short range connection (such as through a BLUETOOTH® connection), the point of interest may be forwarded from the mobile device 94 to the vehicle 12.

Referring back to requesting a navigation route, in another example, the request for a navigation route may be submitted by the vehicle 12 occupant(s), to the in-vehicle navigational radio 92. This may be accomplished by activating the radio 92 and inputting the desired point of interest. Depending on how the navigational radio 92 is constructed, the point of interest may be input by typing (using a keyboard, touch screen, or certain designated buttons on the radio 92) or reciting (using, e.g., microphone 28) the address or the name of the point of interest. Upon submitting the request, the radio 92 retrieves then-current location information of the vehicle 12 from the location detection system 44, and utilizes the vehicle 12 location information and the point of interest information to generate the navigation route for the vehicle 12. The navigation route may be output to the vehicle occupant(s) on a display screen associated with the navigational radio 92 and/or to the audio component 60 (in instances where the route is audibly output to the occupants) via the vehicle bus 34.

Upon generating the navigation route via the navigational radio 92, the telematics unit 14 automatically transmits a notice to the service center 24 that a navigation route has been generated. The notice also includes an electronic copy of the navigation route that was generated. From the notice, the service center 24 may deduce that the vehicle 12 is most likely going to use the navigation route generated by the navigational radio 92 with a relatively high probability. Real time updates may be sent from the telematics unit 14 to the service center 24 so that the service center 24 knows if the user has varied from the requested route.

It is to be understood that the navigation route(s) may not necessarily be determined by generating the route in response to a request from a user. In some instances, the navigation route(s) may be determined from heuristic data (which may be obtained from vehicle probe data which is stored in the user profile at the service center 24), where the heuristic data may be used to predict where the vehicle 12 may be headed at a particular time and/or to determine a habit of the vehicle 12, which may be used for future advertising planning and/or distribution. For instance, the heuristic data may reveal a frequented location, e.g., the vehicle 12 travels from the garage address of its owner to the owner's workplace every Monday through Friday at 8:00 am. The heuristic data may also reveal a previously requested point of interest, and the navigation route(s) may be deduced from this previously requested point of interest. For instance, if the user drives from his/her workplace to a location other than his/her home (such as, e.g., a cottage or second home) every Friday at 5:00 pm, the navigational radio 92 or the service center 24 may infer the intended destination and likely route based upon the vehicle 12 being started at 5:00 pm on a Friday.

The routes are analyzed for statistical frequencies with respect to point of interest in order to determine the types of advertisements that may be desirable along the probable route. Identifying the type of advertisement will also be helpful in identifying a marketing agency 100 to contact about advertising along the road segment. For example, if a majority (e.g., more than 50%) of the users traveling along a particular road segment selected a hotel as a desired point of interest, and a minority (e.g., less than 50%) of the users selected a multitude of other points of interest, the service center 24 may forward hotels as a desired point of interest to the marketing agency 100. The marketing agency 100 may use this information to determine the type of advertisement(s) that should be displayed on the medium 202. The service center 24 may also use the information to communicate other statistically correlated advertisement(s) (e.g., recreational venues, etc.), and then forward this information to the marketing agency 100.

In one example, the type of desired advertisement is based on a common point of interest in a particular geographic region. The common point of interest may, for example, be one that has been requested by several vehicles in the geographic area. For instance, if the vehicle 12 requests a route to a particular destination that is proximate to a common point of interest (such as a museum, a famous golf course, an arena, an amusement park, a landmark, and/or the like), the processor 84 may identify an advertising site along the requested navigation route for advertisement of the common point of interest to the vehicle 12. For instance, if multiple users in Michigan and Ohio requested golf courses in Myrtle Beach, S.C. as a final destination point of interest, the processor 84 may identify a common road segment, highway, or the like (such as, e.g., I-64 near Beckley, W. Va.), and select a medium 202 along I-64 to display an advertisement thereon that relates to a correlated product or service (such as, e.g., an advertisement for a specific brand of golf clubs, or an advertisement for a restaurant located at the clubhouse of one of the golf courses, etc.).

In another example, the desired advertisement may also be linked to an instantaneous increase in vehicle travel along a particular road segment, highway, or the like. In these cases, there may be a sudden need for a particular point of interest (such as a hospital, a shelter, a hotel, etc.). For instance, an evacuation route out of the city of Detroit may include directing traffic along the westbound side of interstate I-94. Noting that the vehicles traveling along this highway most likely include vehicle occupants that are leaving their homes for longer than a day, advertisements for hotels located along westbound I-94 may be displayed at one or more advertising sites along the westbound side of the I-94 highway.

The advertisement may further be determined from a common point of interest based on a seasonal pattern. For example, vehicles in the state of Michigan are more likely to travel to an apple orchard during the months of October and November than during any other months of the year. As such, advertisements for an apple orchard may be displayed at one or more advertising sites along a highway or road segment that a vehicle would ordinarily take to travel to that particular apple orchard.

In still another example, the advertisement may be determined from a length of travel time. In an example, the service center 24 may deduce that the then-current location of the vehicle 12 (taken from the on-board location detection unit 44 in response to a request for such information) is a significant distance away from, e.g., the garage address of the vehicle 12. The service center 24 may identify advertising sites on one or more major road segments or highways near the then-current location of the vehicle 12, and identify a marketing agency 100 that advertises goods/services that may be useful for the vehicle 12 or the vehicle operator that is far away from home. For instance, if the service center 24 deduces that the vehicle 12 is about 120 miles away from home, the marketing agency 100 identified may be one that represents a hotel chain having one or more hotels along or near the road segment.

In yet another example, the advertisement may be determined from a distance the vehicle 12 travels from its starting point (such as, e.g., from its garage address). If the service center 24 deduces that the then-current location of the vehicle 12 is i) a significant distance from its starting point (e.g., 100 miles or more), and ii) the then-current location falls within a designated tourist area, the service center 24 may identify advertising sites on one or more major road segments or highways near the then-current location of the vehicle 12, and identify a marketing agency 100 that advertises goods/services that may be useful for the vehicle 12 or the vehicle operator that is in the tourist area. For instance, if the service center 24 deduces that the vehicle is in Orlando, Fla., which is a significant distance from its starting point of Detroit, Mich., then the marketing agency 100 identified may be one that markets goods/services of local amusement parks or other local hot spots.

In still a further example, the advertisement may be determined by the average estimated time of arrival (ETA) of the vehicle 12. For instance, if the service center 24 deduces that the ETA would be late at night or early in the morning, then the marketing agency 100 identified by may one that markets coffee, hotels, or other points of interest that are open twenty-four hours per day.

Once a route is identified, the processor 84 at the service center 24 identifies a marketing agency 100 that represents an entity that may want to advertise along the probable navigation route. A call center advisor 62, 62′ may utilize the previously identified type of desired advertisement to determine the marketing agency 100 to contact. In one example, the identified marketing agency 100 represents an entity that i) is associated with the requested point of interest, and/or ii) offers goods and/or services directed toward at least one occupant of the vehicle 12 traveling along the probable navigation route(s). Upon making the identification, the service center 24 offers, to the marketing agency 100, advertisement space on a medium (identified by reference numeral 202 in FIG. 2, which will be further described below) that may be used to advertise goods and/or services of the entity that the marketing agency 100 represents. In other words, the marketing agency 100 may, on behalf of the entity it is representing, solicit business directly from targeted vehicles (such as the vehicle 12) traveling along the road segment or highway along which the medium 202 including the advertisement space is located.

In an example, the offer may be submitted to the marketing agency 100 by establishing a voice connection with the agency 100 via the communications module 86 at the service center 24, and verbally reciting the offer to an authorized representative of the agency 100. The offer may also be transmitted to the marketing agency 100 as a data message, e.g., through a packet data session or as an SMS message. In another example, an offer may be auctioned off to a highest bidding marketing agency 100, and the auction may take place on, e.g., the Internet.

In an example, the medium 202 including the advertisement space is a billboard (as shown in FIG. 2), upon which an advertisement may be placed. The billboard may be a non-electronic billboard configured to display a single advertisement, or may be an electronic billboard configured to display a plurality of advertisements in a predetermined order or cycle. In some instances, the electronic billboard is also configured to display advertisements in an on-command format based, at least in part, on the targeted advertising described herein. The billboard may be a stationary medium located at a site along a road segment, expressway, or highway included in the vehicle navigation route(s) generated by the service center 24, generated by the navigational radio 92, or identified using heuristic data. The billboard may also or otherwise be a mobile medium, such as, e.g., an electronic billboard attached to a bus, a car, or another mobile vehicle. Although a billboard is shown in FIG. 2, it is to be understood that the medium 202 may also be selected from any suitable stationary roadside communications device that is external to the vehicle 12, non-limiting examples of which include variable message signs, broadcast speakers, and/or the like. The medium 202 may also be any suitable mobile communications device such as, e.g., a mobile vehicle configured to carry a variable message sign, broadcast speakers, and/or the like.

In response to the offer from the service center 24, the marketing agency 100 may accept or reject the offer. In instances where the marketing agency 100 accepts the offer, the marketing agency 100 will notify the service center 24 of the acceptance, such as, for example through a voice call to the service center 24 or as a data message that is transmitted to the service center 24 from the agency 100. The service center 24 in turn will submit a command to a third party 200 (such as a person or business who places or revises the advertisements on roadside mediums) to display an advertisement selected by the marketing agency 100 on the medium 202. As mentioned above, this advertisement is directed to the targeted vehicle 12.

In instances where the marketing agency 100 rejects the offer, the marketing agency 100 will notify the service center 24 of the same (through a voice call or data message as described above). Upon receiving the rejection, the service center 24 does not contact the third party 200, and a targeted advertisement is not placed on the medium 202.

In one example, so long as the vehicle 12 possesses the probable navigation route(s) transmitted thereto from the service center 24 or generated by the navigational radio 92, the processor 84 at the service center 24 may deduce that the vehicle 12 will most likely travel along the route (or one of the routes) to the desired point of interest. In some instances, it may also be beneficial to verify that the vehicle 12 for which the advertisement is targeted actually passed the medium 202 upon which the advertisement was placed. The verification may be used, by the service center 24, to verify that the vehicle 12 did in fact pass by the advertisement so that the service center 24 may be paid or otherwise compensated by the marketing agency 100 in accordance with a contractual agreement established between them. Verification may also be used to determine when the advertisement should be removed from medium 202. In instances where the medium 202 is an electronic billboard (such as shown in FIG. 2), as soon as the vehicle 12 passes the medium 202, the advertisement targeted to the vehicle 12 may, for example, be switched to another advertisement targeted for another vehicle, switched back to a sequence of randomly selected or predetermined advertisements, or remain on the billboard until the advertisement space is sold to another marketing agency.

In an example, verifying that the targeted vehicle 12 passed by the medium 202 upon which the advertisement is placed may be accomplished by constructing a geofence 204 (shown in dotted lines in FIG. 2) around the medium 202 if the medium is stationary. As shown in FIG. 2, the geofence 204 is constructed around the billboard, as well as around a portion of the road segment 206 upon which the targeted vehicle 12 is traveling. In instances where the medium 202 is mobile (e.g., an electronic billboard attached or mounted to a bus), the geofence 204 may be constructed around a geographic area within which the medium 202 travels. For example, if the bus carrying the medium 202 travels on Woodward Avenue between 12 Mile Road and 14 Mile Road, the geofence may be constructed around Woodward Avenue between 12 Mile Road and 14 Mile Road.

The geofence 204 may be generated by the processor 84 at the service center 24, and includes a boundary defined by GPS coordinates. The processor 36 associated with the telematics unit 14 continuously monitors the then-current location of the vehicle 12, and compares the location of the vehicle 12 with the GPS coordinates defining the geofence 204 boundary. When the targeted vehicle 12 enters the boundary (as determined from the comparison), the processor 36 initiates the transmission of a signal from the telematics unit 14 to the service center 24 that the vehicle 12 did in fact pass by the medium 202. Upon receiving the signal from the telematics unit 14, the service center 24 notifies the marketing agency 100 (via, e.g., a voice call or a data message) that the targeted vehicle 12 passed by the medium 202 upon which the advertisement was placed. In another example, the telematics unit 14 periodically sends the GPS location of the vehicle 12 to the service center 24, which compares the information to the route leading up to the geofence 204 boundary to determine whether or not the vehicle 12 passed by the medium 202.

In another example of the method, prior to identifying the marketing agency 100, the method may include collecting, at an advertising site along a particular road segment, demographic data from a plurality of vehicle probes. The demographic data may be collected by identifying the vehicle 12 or a service center account number associated with the user and/or vehicle, and then retrieving appropriate user profiles associated with the vehicle 12 owner or other authorized vehicle 12 operators stored in the database 72 at the service center 24. The vehicle 12 may be identified, for instance, by querying the telematics unit 14 as the vehicle 12 is traveling along the road segment for vehicle data including the vehicle identification number (VIN) or other information identifying the vehicle 12. The querying may be accomplished, for example, using short-range communications such as, e.g., dedicated short-range communication (DSRC), WiFi, etc., or via the geofence 204 stored in the telematics unit 14, which initiates the call to the service center 24 when the vehicle 12 enters the geofence 204.

The demographic data of the vehicle 12 occupants may also be obtained by a recording system 96 configured to capture a voice print of one or more of the vehicle 12 occupants. In this example, the recording system 96 may be activated on command from the telematics unit 14 upon recognizing that the environment of the cabin area of the vehicle 12 is such that the recording system 96 can capture a relatively clean voice print (e.g., a vehicle occupant is speaking without the radio being on). Once activated, the recording system 96 records or otherwise captures verbal tones from inside the cabin area of the vehicle 12, and makes a voice print from these tones. The voice print is transmitted to the service center 24, which determines an approximate age of each of the speakers captures in the recording.

In other cases, the demographic data may be collected from camera images of the internal cabin area of the vehicle 12 taken using the in-vehicle camera(s) 98. These images may include one or more of the occupants of the vehicle 12. Upon capturing the images, the telematics unit 14 transmits the images to the service center 24, which determines an approximate age of the vehicle 12 occupants from the images. In an example, the images are taken upon detecting that the vehicle 12 is in an ignition-on state, upon opening/closing one or more vehicle 12 doors, when the navigational radio 92 or the telematics unit 14 sends a signal that a point of interest has been selected, and/or the like, and/or combinations thereof

The demographic data may additionally be collected from heuristics of the vehicle 12 itself. More specifically, one or more of the in-vehicle sensors 64 may be configured to detect various characteristics of components inside the cabin area of the vehicle 12. For example, a sensor 64 may be configured to detect the seat track position, which may be used to deduce the approximate size of the person occupying the seat. In this example, if the seat track position is pulled all of the way back, the service center 24 may deduce that a demographic of the vehicle occupant is tall and most likely an adult. In another example, a sensor 64 may be configured to detect the seat weight, which may also be used to deduce the approximate size of the vehicle occupant. For instance, if the seat weight (which includes the weight of the seat as well as the person occupying the seat) is low (relative to a particular standard), the service center 24 may deduce that the person occupying the seat is small and, if the weight is very low, is perhaps a child. In still another example, a service center 24 may be able to retrieve information pertaining to a radio preset from the vehicle 12. If, for example, the radio is preset on an oldies station, the service center 24 may deduce that at least one of the vehicle occupants is older in age.

It is to be understood that the foregoing examples of how the demographic data is obtained are not inclusive, and that one skilled in the art would know other ways of obtaining the demographic data. These other ways may also be used or are otherwise applicable to the instant disclosure.

The demographic data may then be used, by the service center 24, to identify an appropriate type of advertisement and an appropriate marketing agency 100.

In an example, the demographic data of the driver and/or other vehicle occupants are determined at particular times of the day. For example, the service center 24 may deduce that the demographic of vehicle occupants on a particular highway at 7:00 am on a weekday would include members of the working class, and thus are most likely adults. In another example, the service center 24 may deduce that the demographic of vehicle occupants on a particular road segment at 8:00 am on a weekday would include school-age children either alone (such as high school students that drive themselves to school) or accompanied by an adult (such as a parent, nanny, etc.).

In an example, if the demographic data reveals that vehicles carrying adults between the ages of 40 and 50 is the predominant demographic traveling on a particular road segment between 7:00 am and 8:00 am, a marketing agency 100 may be identified for advertising goods/services directed to adults between the ages of 40 and 50. If the demographic data also reveals that vehicles carrying adults between the ages of 60 and 80 is the predominant demographic traveling on the same road segment between 8:00 am and 10:00 am, another marketing agency 100 may be identified for advertising goods/services directed to adults between the ages of 60 and 80. In instances where an electronic billboard is used as the advertising medium 202, advertisement space on the medium 202 may be used to advertise goods/services of the first marketing agency 100 (i.e., the agency 100 that represents producers of goods/services directed to adults between the ages of 40 and 50) from 7:00 am to 8:00 am. Then, at 8:00 am, the advertisement displayed on the billboard may be switched to another advertisement of the other (or second) marketing agency 100 (i.e., the agency 100 that represents manufacturers or retailers of goods/services directed to adults between the ages of 60 and 80). This second advertisement may be displayed during the two hour period from 8:00 am to 10:00 am, and then switched to yet another advertisement directed to another demographic starting at 10:00 am. If no particular demographic is identified after 10:00 am, the billboard may continue to display the last advertisement, or may revert to a predetermined sequence or random cycle of advertisements not necessarily directed to any particular demographic. If a new demographic of vehicle occupants are determined for a later time interval (such as between 3:00 pm and 4:00 pm), the electronic billboard may be configured to switch to an advertisement at 3:00 pm directed to that new demographic.

It is to be understood that the advertisements being switched on the electronic billboard are pre-uploaded in or sent to a processor (not shown) associated with the billboard. In one example, the pre-uploaded advertisements include advertisements directed to each demographic that was determined to pass by the advertising site. In some cases, the advertisements are placed into a sequence so that particular advertisements are shown at particular times of the day. This sequence may be updated or changed based on new demographic data obtained from the advertising site.

In another example, the demographic data of the vehicle driver and/or occupants may be determined based on whether or not the vehicle 12 is traveling outside of its home town, city, state, etc. For instance, the service center 24 may retrieve the vehicle identification number (VIN) or other information that identifies the vehicle 12, and the garage address of the vehicle 12 owner may be retrieved from the user profile. The service center 24 (e.g., processor 84) also retrieves then-current GPS location information of the vehicle 12, and compares the GPS information with the garage address to determine where the vehicle 12 is. If the service center 24 determines that the vehicle 12 is then-currently located outside of its hometown, the service center 24 deduces that the vehicle 12 is traveling. Based, at least in part, on where the vehicle 12 is then-currently located and the time of year that the vehicle 12 is traveling, the service center 24 may deduce that the demographic of the vehicle 12 may include, for example, a family (e.g., if the vehicle 12 is in Orlando, Fla. during a winter holiday), a particular gender (e.g., the vehicle occupants may be male if the vehicle 12 is at a deer hunting facility), a particular age group (e.g., the vehicle occupants may be in college if the vehicle 12 is in Key West, Fla. during spring break time), etc.

The demographic data of the driver and/or other vehicle occupants may also be determined in real time directly from vehicles 12 approaching a particular advertising site. In this example, the demographic data is collected, at an advertising site along a road segment, from a plurality of probes located by the advertising site (e.g., the demographic data may be collected using traffic cameras that take images useful for identifying drivers and/or passengers of the vehicle 12). The demographic data is then utilized in real time to identify an appropriate advertisement type and marketing agency 100. Advertisement space is offered to the identified agency 100, and if accepted, an advertisement of the marketing agency 100 is displayed on the billboard.

The advertisement of the identified marketing agency 100 may remain on the billboard until a second marketing agency 100 is identified (based, at least in part, on newly collected demographic data from the probe vehicles), or remains on the billboard for a predetermined amount of time before other advertisements that are part of a predetermined sequence replace it. In instances where the new demographic data reveals a change in the demographic of the probe vehicles passing by the advertising site, the new (or additional) demographic data is utilized to identify another suitable ad type or another suitable marketing agency 100. Advertisement space is then offered to the identified agency 100, and if accepted, an advertisement of the other marketing agency 100 replaces the first advertisement on the billboard.

In yet another example, the electronic billboard may automatically react to a change in the demographic of approaching vehicles based, at least in part, on the demographic data collected in real time. Upon detecting a change in the demographic (e.g., from images captured by a traffic camera at the medium 202 of new passengers that have been acquired during the trip; from newly recorded voice prints; from images captured by a camera proximate to the medium 202 to confirm or alter results from previously compared voice prints; etc.) the electronic billboard may automatically switch the advertisement then-currently being displayed on the billboard to another advertisement that is targeted to the changed demographic.

Another example of the method disclosed herein is directed to advertising to a plurality of targeted vehicles. This example of the method very generally involves identifying a common point of interest of a plurality of vehicles, and then displaying an advertisement on a medium (such as the medium 202 shown in FIG. 2) located along a road segment, where the advertisement is directed to the several targeted vehicles.

In this example, the processor 84 at the service center 24 may identify the common point of interest from a number of requests for navigation routes to that common point of interest. It is to be understood that to qualify as a common point of interest for purposes of targeted advertising, the requests for the navigation route from the plurality of vehicles should be made within a predefined window of time. For example, if the service center 24 receives a plurality of requests for a navigation route to X State University Stadium on October 1, then the service center 24 may identify X State University Stadium as a common point of interest for purposes of targeted advertising on October 1. If, on the other hand, a plurality requests for navigation routes to X State University Stadium is received at random days of the year, the service center 24 most likely will not identify the point of interest as common for purposes of advertising.

To reiterate from above, the common point of interest may be identified other than from requests for navigation routes. For instance, the common point of interest may be identified from a number of requests for information pertaining to the common point of interest, a season pattern (e.g., apple orchards in Michigan in the fall), and/or the like.

Upon identifying the common point of interest, the service center 24 determines at least one road segment associated with the common point of interest, where such road segment includes an advertising site viewable by passing vehicles (such as the targeted vehicles 12). The road segment may be a road segment upon which the common point of interest is located, a commonly-traveled road segment linked with the road segment upon which the common point of interest is located, an expressway including an exit to the road segment upon which the common point of interest is located, or combinations thereof. For instance, if the common point of interest is X State University Stadium, then the service center 24 may identify I-96 as a road segment that includes an advertising site for targeted advertising to vehicles traveling to that common point of interest.

The service center 24 also identifies a marketing agency 100 that represents an entity that offers products and/or services that can be correlated with the common point of interest. Using the example above, the marketing agency 100 may be selected, e.g., from those that represent distributors of X State University apparel, restaurants at or near X State University, etc. The service center 24 thereafter offers, to the marketing agency 100, advertisement space on the medium 202 located along the road segment, and upon receiving an acceptance of the offer, submits a command to the third party 200 to display an advertisement on the medium 202.

While several examples have been described in detail, it will be apparent to those skilled in the art that the disclosed examples may be modified. Therefore, the foregoing description is to be considered exemplary rather than limiting.

1. A method of advertising to a targeted vehicle, comprising:
determining at least one vehicle navigation route to a point of interest;
via the processor at the service center, identifying a marketing agency that represents an entity that at least one of i) is associated with the point of interest, or ii) offers at least one of goods or services directed toward at least one occupant of the targeted vehicle traveling along the at least one vehicle navigation route;
offering, to the marketing agency, advertisement space on a medium external to the targeted vehicle and located along the at least one vehicle navigation route; and
upon receiving acceptance of the offer, via the processor at the service center, submitting a command to a third party facility to display an advertisement of the marketing agency on the medium, the advertisement being directed to the targeted vehicle.

2. The method as defined in claim 1 wherein determining the at least one vehicle navigation route includes:
receiving, at a service center, a user request for information pertaining to the point of interest; and
utilizing the requested point of interest to generate at least one probable vehicle navigation route.

3. The method as defined in claim 1 wherein the determining of the at least one vehicle navigation route is based on a common point of interest in a particular geographic region, a common point of interest based on a seasonal pattern, a sudden need for a particular point of interest, a length of travel time, a distance from a starting point, or combinations thereof

4. The method as defined in claim 1 wherein after the at least one vehicle navigation route is determined and prior to identifying the marketing agency, the method further comprises transmitting the at least one vehicle navigation route from the service center to a telematics unit disposed in the targeted vehicle.

5. The method as defined in claim 1, further comprising verifying that the targeted vehicle passed the medium located along the at least one vehicle navigation route by:
via the processor at the service center, constructing a geofence around the medium;
when the targeted vehicle enters a boundary defined by the geofence, initiating a signal that notifies the service center that the targeted vehicle passed by the medium located along the at least one vehicle navigation route; and
transmitting the signal from the telematics unit to the service center.

6. The method as defined in claim 5, further comprising notifying the marketing agency that the targeted vehicle did pass by the medium located along the at least one vehicle navigation route.

7. The method as defined in claim 1 wherein prior to identifying the marketing agency, the method further comprises:
collecting, at an advertising site along a road segment, demographic data from a plurality of vehicle probes at a plurality of predefined time periods; and
utilizing the demographic data to identify an appropriate marketing agency.

8. The method as defined in claim 7 wherein the medium is an electronic billboard, and wherein upon receiving the acceptance of the offer from the marketing agency, the method further comprises:
displaying a first advertisement on the electronic billboard during one of the plurality of time periods, the first advertisement directed to a first demographic of vehicles; and
displaying a second advertisement on the electronic billboard during an other of the plurality of time periods, the second advertisement directed to a second demographic of vehicles.

9. The method as defined in claim 7 wherein the collected demographic data reveals no particular demographic of the plurality of vehicle probes, and wherein the method further comprises displaying one of a predetermined sequence of advertisements or a random cycle of advertisements on the medium until a particular demographic of the plurality of vehicle probes is identified.

10. The method as defined in claim 1 wherein prior to identifying the marketing agency, the method further comprises:
collecting, at an advertising site along a road segment, demographic data from a plurality of vehicle probes passing by the advertising site;
utilizing the demographic data in real time to identify an appropriate marketing agency;
offering the advertisement space on the medium to the identified appropriate marketing agency; and
upon receiving acceptance of the offer, automatically displaying a first advertisement on the medium, the first advertisement being associated with the identified appropriate marketing agency.

11. The method as defined in claim 10 wherein the medium is an electronic billboard, and wherein after the first advertisement is displayed on the electronic billboard, the method further comprises:
collecting, at the advertising site along the road segment, additional demographic data from a plurality of other vehicle probes passing by the advertising site after the first advertisement has been displayed;
identifying a change in the additional demographic data from the previously collected demographic data;
utilizing the additional demographic data to identify a new marketing agency;
offering the advertisement space to the new marketing agency; and
upon accepting the offer, automatically switching the first advertisement to a second advertisement, the second advertisement being correlated with the new marketing agency and being directed to a demographic of the plurality of other vehicle probes.

12. The method as defined in claim 1 wherein determining the at least one vehicle navigation route includes:
receiving, at a navigational radio, a user request for the at least one vehicle navigation route, the request including information selected from an identifier for the point of interest or an address associated with the point of interest; and
via the navigational radio, utilizing the information to generate the at least one vehicle navigation route.

13. The method as defined in claim 1 wherein determining the at least one vehicle navigation route includes analyzing heuristics to predict the vehicle navigation route.

14. A method of advertising to a plurality of targeted vehicles, comprising:
via a processor at a service center, identifying a common point of interest of the plurality of targeted vehicles;
via the processor, determining at least one road segment associated with the common point of interest;
via the processor, identifying a marketing agency that is correlated with the common point of interest;
offering, to the marketing agency, advertisement space on a medium external to the plurality of targeted vehicles and located along the at least one road segment; and
upon receiving acceptance of the offer, via the processor, submitting a command to a third party facility to display an advertisement of the marketing agency on the medium located along the at least one road segment.

15. The method as defined in claim 14 wherein the common point of interest is identified from a number of requests for a navigation route to the common point of interest from the plurality of targeted vehicles.

16. The method as defined in claim 14 wherein the at least one road segment associated with the common point of interest includes a road segment upon which the common point of interest is located, a commonly-traveled road segment linked with the road segment upon which the common point of interest is located, a highway including an exit to the road segment upon which the common point of interest is located, or combinations thereof

17. A system for advertising to a targeted vehicle, comprising:
a service center or a navigational radio, each including a processor configured to determine at least one navigation route to a point of interest requested from the targeted vehicle;
a marketing agency that represents an entity that at least one of i) is associated with the requested point of interest, or ii) offers at least one of goods or services directed toward at least one occupant of the targeted vehicle traveling along the at least one vehicle navigation route; and
a medium external to the targeted vehicle and configured to display an advertisement thereon, the advertisement being displayed in response to the marketing agency accepting an offer, from the service center, for advertisement space on the medium, and the advertisement being directed to the targeted vehicle.

18. The system as defined in claim 17 wherein the medium is an electronic billboard, and wherein the electronic billboard is configured to switch advertisements in real time based on demographic data collected from a plurality of vehicle probes traveling along the at the least one navigation route.

19. The system as defined in claim 17 wherein the service center further includes a communications module configured to transmit the at least one navigation route to the targeted vehicle.

20. The system as defined in claim 17, further comprising:
a geofence constructed around the medium; and
a telematics unit operatively disposed in the vehicle, the telematics unit including a processor configured to generate a trigger when the targeted vehicle enters the boundary defined by the geofence;
wherein the telematics unit is configured to transmit a notification to the service center that the targeted vehicle has entered the boundary and thus passed the medium.

21. The system as defined in claim 17, further comprising a third party facility configured to display the advertisement on the medium.

22. The system as defined in claim 17 wherein the medium is a roadside communications device.

23. The system as defined in claim 17 wherein the medium is stationary, mobile, or combinations thereof
